(19) United States
(12) Patent Application Publication
(10) Pub. No.: US 2006/0026375 A1
(43) Pub. Date: Feb. 2, 2006

(54) Memory controller transaction scheduling algorithm using variable and uniform latency

(76) Inventors: Bruce A. Christenson, Forest Grove, OR (US); Chitra Natarajan, Flushing, NY (US)

Correspondence Address: MARGER JOHNSON & MCCOLLOM, P.C., 210 SW MORRISON STREET, SUITE 400, PORTLAND, OR, 97204, US

(21) Appl. No.: 10/909,084

(22) Filed: Jul. 30, 2004

(51) Int. Cl. G06F 13/28; G06F 12/00

(52) U.S. Cl. 711/167; 711/158

(57) ABSTRACT

A memory method may select a latency mode, such as read latency mode, based on measuring memory channel utilization. Memory channel utilization, for example, may include measurements in a memory controller queue structure. Other embodiments are described and claimed.

### BACKGROUND OF THE INVENTION

Conventional memory controllers often control multiple memory devices including modules, chips, Dual Inline Memory Modules (DIMMs), agents, etc. Distances from the memory controller to controlled devices may vary, resulting in different signal propagation times between the memory controller and the devices. Likewise, certain topologies, for example a point-to-point memory topology, may have additional delays at each point (node), causing greater variation in signal propagation duration between the memory controller and the devices.

Generally, latency is the time between a stimulus and a response to the stimulus. Some conventional memory architectures have uniform latency on a memory channel between a memory controller and its controlled devices. The memory channel may include data paths leading to memory for either control or data signals. Memory channels may also include a memory controller and its controlled devices. In an example uniform latency memory channel, a conventional memory controller may schedule memory transactions using a DDR2 (Double Data Rate version 2) posted CAS (column address strobe) feature, such that when an activate DRAM (dynamic random access memory) command (RAS, row address strobe), is scheduled, the scheduling and timing of a read or write DRAM command (CAS) is fixed for the next clock cycle. This method of scheduling DRAM commands is easy to design and is effective when a memory channel has uniform latency.

Unfortunately, latency to multiple memory devices can vary. For example, point-to-point topologies inherently have different distances from a memory controller to its controlled devices. Likewise, processing at each point involves additional latencies. Memory controllers may thus utilize a variable latency mode for a memory channel for lower average latency. Unfortunately, if a memory controller has variable latency then the efficiency of the memory channel may drop at high utilizations, for example, from scheduling conflicts (bubbles) due to the variable read latency feature.

### BRIEF DESCRIPTION OF THE DRAWINGS

FIG. 1 illustrates a prior art RamLink memory system.

FIG. 2 illustrates memory controller throughput based upon latency mode.

FIG. 3 is a flowchart illustrating a method for controlling latency mode based on memory channel utilization.

FIG. 4 is a block diagram of an exemplary computer system that may utilize embodiments of the invention.

### DETAILED DESCRIPTION OF THE INVENTION

Inventive principles illustrated in this disclosure are not limited to the specific details disclosed herein.

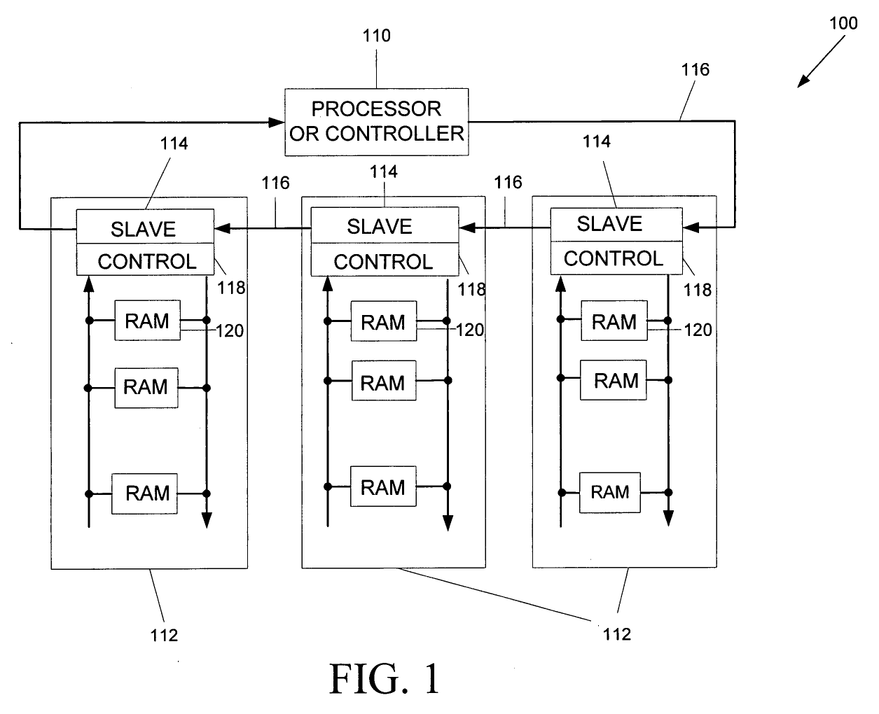

A review of a conventional memory architecture will aid understanding of methods of the present invention. FIG. 1 illustrates a prior art memory system known informally as RamLink, which was proposed as a standard by the Institute of Electrical and Electronics Engineers (IEEE). The standard was designated as IEEE Std 1596.4-1996 and is known formally as IEEE Standard for High-Bandwidth Memory Interface Based on Scalable Coherent Interface (SCI) Signaling Technology (RamLink).

The system of FIG. 1 includes a processor or controller 110 (memory controller) and one or more memory modules 112. The memory controller 110 is typically either built into a processor or fabricated on a companion chipset for a processor, but may be any logic device that can operate with the memory channel. Each memory module 112 has a slave interface 114 that has one link input and one link output. The components are arranged in a RamLink signaling topology known as RingLink with unidirectional links, for example a memory channel 116, between components. A control interface 118 on each module interfaces the slave interface 114 with memory devices 120. In FIG. 1, the memory devices 120 may be random access memory (RAM).

In the system shown in FIG. 1, another RamLink signaling topology known as SyncLink is used between the slave interfaces and memory devices.

The purpose of the RamLink system is to provide a processor with high-speed access to the memory devices. Data is transferred between the memory controller and modules in packets that circulate along the RingLink. The controller is responsible for generating all request packets and scheduling the return of slave response packets. In the present example, scheduling is complicated by the memory topology.

A write transaction is initiated when the controller sends a request packet including command, address, time, and data to a particular module. The packet is passed from module to module until it reaches the intended slave, which then passes the data to one of the memory devices for storage. The slave then sends a response packet, which is passed from module to module until it reaches the controller to confirm that the write transaction was completed.

A read transaction is initiated when the controller sends a request packet including command, address, and time to a module. The slave on that module retrieves the requested data from one of the memory devices and returns it to the controller in a response packet, which is again passed from module to module until it reaches the controller.

Write or read transactions involve different latencies for the different memory devices 120. For example, memory controller 110 has different signal distances to each memory device 120. Additionally, in this example, latency may arise in the limited processing internal to each memory device 120.

Variable latencies between the memory controller 110 and each memory device 112 affect control of the memory channel 116, in particular in relation to changing memory channel 116 utilization or throughput. FIG. 1 shows a point-to-point memory architecture, but the inventive principles extend to any memory architecture with either variable latencies or changing channel utilizations.

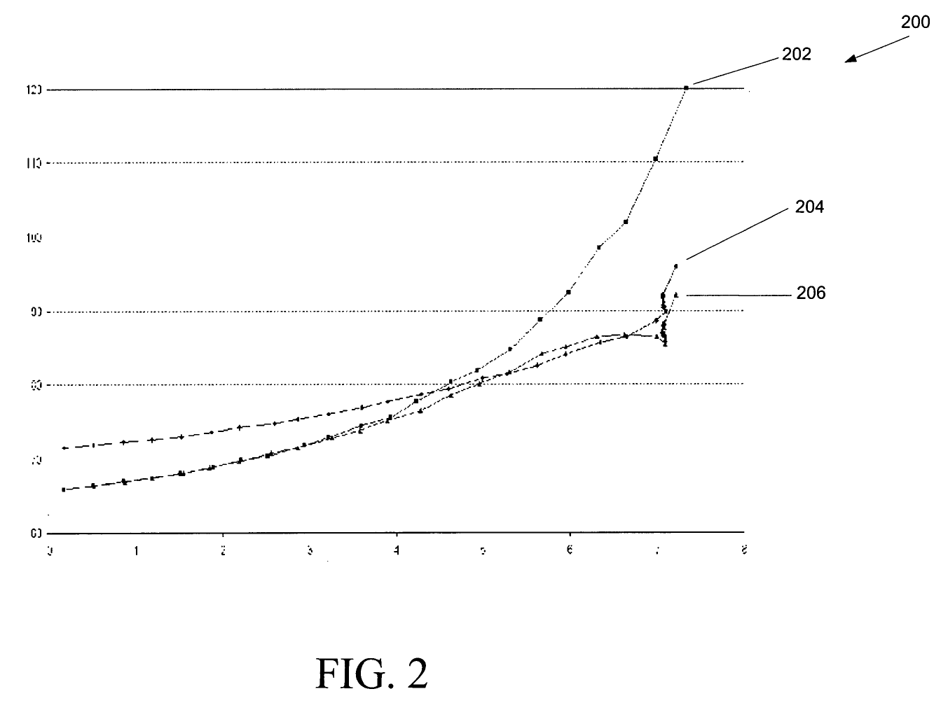

FIG. 2 illustrates example memory controller throughputs based upon latency mode. The vertical axis in FIG. 2 represents latency, for example an average memory controller read latency. The horizontal axis in FIG. 2 represents utilization, for example delivered memory controller throughput. Generally, latency increases as throughput increases.

In FIG. 2, line 202 shows the memory performance when a memory controller is running in a variable latency mode. Line 202 is characterized by low relative latency when the memory has low throughput. Line 204 shows the memory performance when a memory controller is running in a uniform latency mode. Line 204 is characterized by low relative latency with higher memory throughput but higher relative latency with lower memory throughput. Line 206 represents a dynamic variable/uniform latency memory performance maintaining the lower relative latency of variable latency at low utilization and the lower relative latency of uniform latency in high throughput conditions.

Generally, by monitoring channel utilization, a memory controller, or other device, may adjust latency mode. The present example dynamically adjusts between uniform and variable latency states based upon memory channel utilization. An embodiment method may measure memory channel utilization, and switch from a variable read latency mode to a uniform read latency mode in response to a threshold utilization. An example memory channel utilization measurement involves measuring how full a queue is in a memory controller. This measurement may help determine latency mode for the memory channel or controller, as will be illustrated in the embodiment method below.

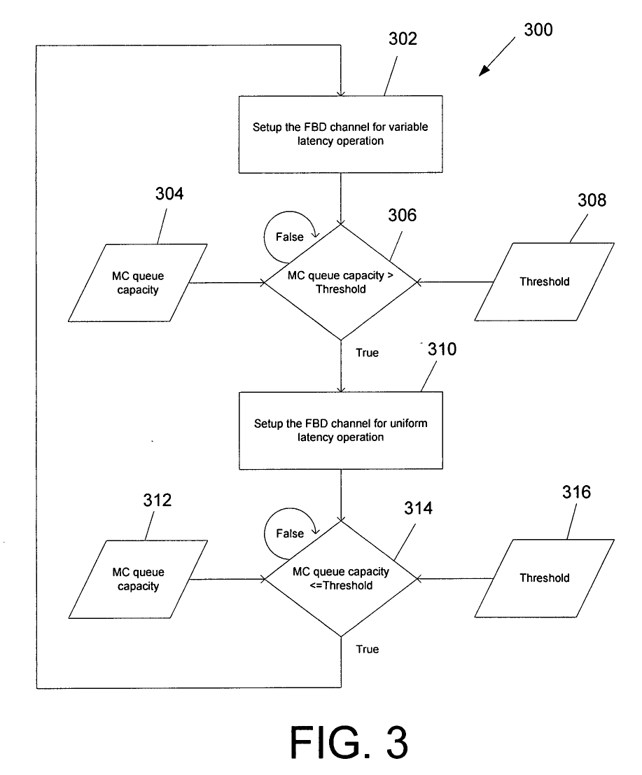

FIG. 3 is a flowchart illustrating an embodiment method 300 according to the inventive principles of this disclosure. An embodiment may adjust memory channel latency settings based upon channel utilization. For example, an embodiment may comprise a method for measuring memory channel utilization and selecting between a variable read latency mode and uniform read latency mode based on the utilization. A method may measure how many requests are queued in a memory controller queue structure.

The example 300 compares memory controller queue capacity 304 versus a threshold 308 and at the threshold adjusts the memory channel to uniform latency operation. A method may select between latency modes by comparing utilization to a programmable register specifying a threshold 308. An embodiment may dynamically select between latency modes. An embodiment memory controller algorithm may maintain transaction level read and write scheduling while taking advantage of the lower average idle latency of variable latency memory channels and maintaining efficient channel operation at high utilizations.

Referring to FIG. 3, in block 302, the method may initialize a memory channel for variable latency operation. The inventive principles are not restricted to any initialization state. For example, an embodiment might initialize the channel to uniform latency.

In block 306, memory controller queue capacity 304 is compared to a threshold 308. In the present embodiment, if memory controller queue capacity 304 is not greater than the threshold 308, then the method repeats the block 306 comparison. If memory controller queue capacity 304 is greater than the threshold 308, then the embodiment method 300 adjusts memory channel latency to uniform latency operation 310. An embodiment may utilize the flowchart in FIG. 3 to determine initialization state.

Memory channel utilization may be determined by any method. For example, instead of measuring queue capacity 304, an embodiment may measure queue remaining capacity. Another example memory channel utilization determination involves counting a number of transactions that are launched per clock.

Likewise, the threshold 308 may be adjusted so the comparison of memory channel utilization may be equal to, less than, etc., the threshold 308. Thus, inventive principles are not limited to the embodiment in FIG. 3.

Additionally, the embodiment method 300 may still monitor utilization and switch back to the previous memory channel latency mode. Referring to FIG. 3, after the channel is set for uniform latency operation in 310, then decision block 314 again compares memory controller queue capacity 312 to a threshold 316.

The present embodiment measures if memory controller queue capacity 312 is less than or equal to the threshold 316. In this embodiment, if memory controller queue capacity is equal to or less than the threshold 316, then the memory channel is again set for variable latency operation in block 302. If the decision block is false, then the method 300 simply repeats block 314.

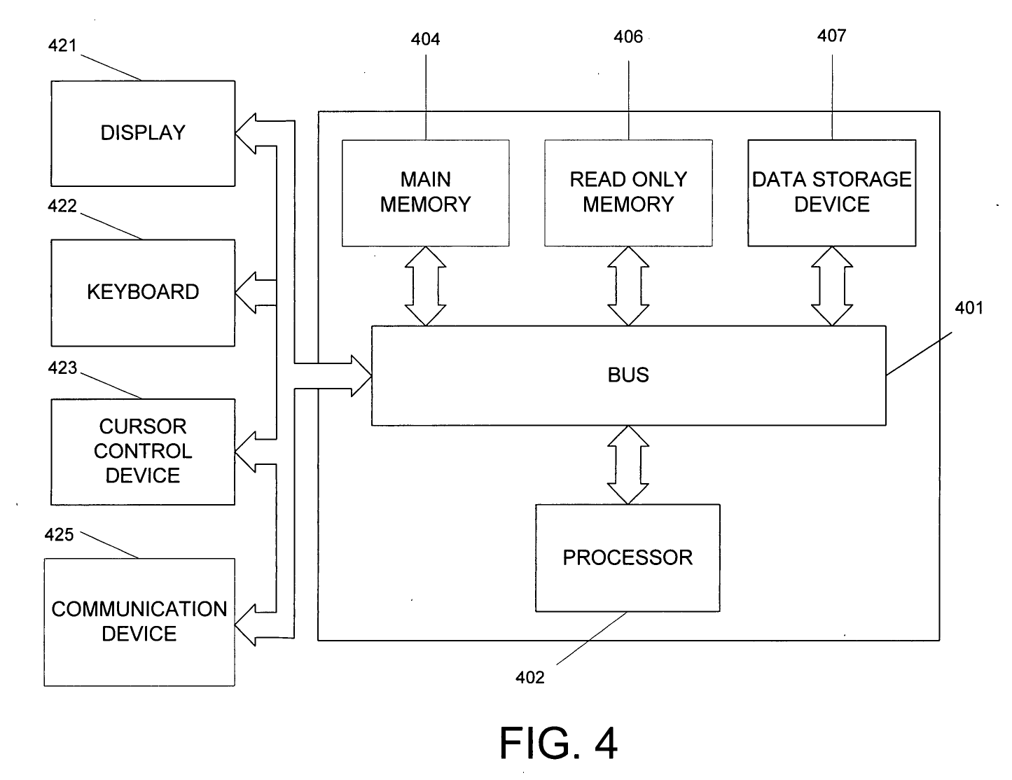

FIG. 4 is a block diagram of an exemplary computer system as may be utilized in embodiments of the invention. The invention is not limited to a single computing environment. Moreover, the architecture and functionality of the invention as taught herein and as would be understood by one skilled in the art is extensible to other types of computing environments and embodiments in keeping with the scope and spirit of the invention.

The invention provides for various methods, computer-readable mediums containing computer-executable instructions, and apparatus. With this in mind, the embodiments discussed herein should not be taken as limiting the scope of the invention; rather, the invention contemplates all embodiments as may come within the scope of the appended claims.

The present invention includes various operations, which will be described below. The operations, may be performed by hard-wired hardware, or may be embodied in machine-executable instructions that may be used to cause a general purpose or special purpose processor, or logic circuits programmed with the instructions to perform the operations. Alternatively, the operations may be performed by any combination of hard-wired hardware, and software driven hardware.

The present invention may be provided as a computer program product that may include a machine-readable medium, stored thereon instructions, which may be used to program a computer (or other programmable devices) to perform a series of operations according to the present invention.

The machine-readable medium may include, but is not limited to, floppy diskettes, optical disks, compact disk read only memories (CD-ROM's), digital versatile disks (DVD's), magno-optical disks, ROM's, RAM's, erasable programmable read-only memory (EPROM's), electrically erasable programmable read-only memory (EEPROM's), hard drives, magnetic or optical cards, flash memory, or any other medium suitable for storing electronic instructions.

The present invention may be downloaded as a computer software product, wherein the software may be transferred between programmable devices by data signals in a carrier wave or other propagation medium via a communication link (e.g. a modem or a network connection).

FIG. 4 illustrates an exemplary computer system 400 upon which embodiments of the invention may be implemented. For example, an apparatus comprising a machine-readable medium may contain instructions that, when executed, cause a machine to measure memory channel utilization, and select between a variable read latency mode and uniform read latency mode based on the measured utilization.

An embodiment may include an apparatus comprising instructions that, when executed, cause a machine to measure how many requests are in a memory controller queue structure. A apparatus may comprise instructions that cause a machine to dynamically select between latency modes.

Additionally, an apparatus may comprise instructions that cause a machine to compare a measured memory channel utilization to a programmable register specifying a threshold value. Another example apparatus may comprise instructions that cause a machine to initialize a memory channel to a variable read latency mode.

In FIG. 4, computer system 400 comprises a bus or other communication means 401 for communicating information, and a processing means such as processor 402 coupled with bus 401 for processing information. Computer system 400 further comprises a random access memory (RAM) or other dynamically-generated storage device 404 (referred to as main memory), coupled to bus 401 for storing information and instructions to be executed by processor 402. Main memory 404 also may be used for storing temporary variables or other intermediate information during execution of instructions by processor 402.

Computer system 400 also comprises a read only memory (ROM) and/or other static storage device 406 coupled to bus 401 for storing static information and instructions for processor 402.

A data storage device 407 such as a magnetic disk or optical disk and its corresponding drive may also be coupled to computer system 400 for storing information and instructions. Computer system 400 can also be coupled via bus 401 to a display device 421, such as a cathode ray tube (CRT) or Liquid Crystal Display (LCD), for displaying information to an end user.

Typically, an alphanumeric input device (keyboard) 422, including alphanumeric and other keys, may be coupled to bus 401 for communicating information and/or command selections to processor 402. Another type of user input device is cursor control 423, such as a mouse, a trackball, or cursor direction keys for communicating direction information and command selections to processor 402 and for controlling cursor movement on display 421.

A communication device 425 is also coupled to bus 401. The communication device 425 may include a modem, a network interface card, or other well-known interface devices, such as those used for coupling to Ethernet, token ring, or other types of physical attachment for purposes of providing a communication link to support a local or wide area network, for example. In this manner, the computer system 400 may be networked with a number of clients, servers, or other information devices.

It is appreciated that a lesser or more equipped computer system than the example described above may be desirable for certain implementations. Therefore, the configuration of computer system 400 will vary from implementation to implementation depending upon numerous factors, such as price constraints, performance requirements, technological improvements, and/or other circumstances.

Although a programmed processor, such as processor 402 may perform the operations described herein, in alternative embodiments, the operations may be fully or partially implemented by any programmable or hard coded logic, such as Field Programmable Gate Arrays (FPGAs), TTL logic, or Application Specific Integrated Circuits (ASICs), for example.

Additionally, the method of the present invention may be performed by any combination of programmed general-purpose computer components and/or custom hardware components. Therefore, nothing disclosed herein should be construed as limiting the present invention to a particular embodiment wherein the recited operations are performed by a specific combination of hardware components.

1. A method comprising:
measuring memory channel utilization; and
selecting between a variable read latency mode and uniform read latency mode based on the utilization.

2. A method according to claim 1 wherein measuring memory channel utilization involves measuring how many requests are queued in a memory controller queue structure.

3. A method according to claim 1, comprising dynamically selecting between latency modes.

4. A method according to claim 1, wherein selecting between latency modes involves comparing utilization to a programmable register specifying a threshold value.

5. A method according to claim 1 comprising initializing a memory channel to a variable read latency mode.

6. A method comprising:
measuring memory channel utilization; and
switching from a variable read latency mode to a uniform read latency mode in response to a threshold utilization.

7. A method according to claim 6 wherein measuring memory channel utilization involves measuring how many requests are in a memory controller queue structure.

8. A method according to claim 6 comprising dynamically selecting between latency modes.

9. A method according to claim 6 wherein selecting between latency modes involves comparing utilization to a programmable register specifying a threshold value.

10. A method according to claim 6 comprising initializing a memory channel to a variable read latency mode.

11. An apparatus comprising a machine-readable medium containing instructions that, when executed, cause a machine to:
measure memory channel utilization; and
select between latency modes based on the measured utilization.

12. An apparatus according to claim 11, wherein the instructions cause a machine to select between a variable read latency mode and uniform read latency mode based on the measured utilization.

13. An apparatus according to claim 1.1 comprising instructions that, when executed, cause a machine to measure how many requests are in a memory controller queue structure.

14. An apparatus according to claim 11 comprising instructions that, when executed, cause a machine to dynamically select between latency modes.

15. An apparatus according to claim 11 comprising instructions that, when executed, cause a machine to compare a measured memory channel utilization to a programmable register specifying a threshold value.

16. An apparatus according to claim 1I comprising instructions that, when executed, cause a machine to initialize a memory channel to a variable read latency mode.

17. A device comprising:
a sensor to sense memory channel utilization; and
a switch coupled with the sensor to allow selection between latency modes.

18. The device of claim 17 further comprising a sensor to measure how many requests are queued in a memory controller queue structure.

19. The device of claim 17, wherein the switch further comprises a processor to allow selection between latency modes based on channel utilization.

20. The device of claim 17, wherein the device further comprises a memory controller, the memory controller to select between latency modes based on channel utilization.

21. A system comprising:
a memory;
a processor; and
a device comprising:
a sensor to sense memory channel utilization; and
a switch coupled with the sensor to allow selection between latency modes.

22. The system of claim 21 wherein the device further comprises a sensor to measure how many requests are queued in a memory controller queue structure.

23. The system of claim 21 wherein the memory comprises multiple memory modules.

24. The system of claim 21 wherein the memory comprises multiple DIMMs.
